(19) United States
(12) Patent Application Publication
(10) Pub. No.: US 2020/0107615 A1
(43) Pub. Date: Apr. 9, 2020

(54) COMBINATION STRAP CONNECTOR AND ADJUSTER

(71) Applicant: CHECKMATE LIFTING & SAFETY LTD, Kent (GB)

(72) Inventor: Oliver Auston, Faversham (GB)

(73) Assignee: CHECKMATE LIFTING & SAFETY LTD, Kent (GB)

(21) Appl. No.: 16/592,028

(22) Filed: Oct. 3, 2019

Related U.S. Application Data
(60) Provisional application No. 62/743,022, filed on Oct. 9, 2018.

(51) Int. Cl. A44B 11/25; A62B 35/00

(52) U.S. Cl. CPC A44B 11/2557; A62B 35/0031; A62B 35/0037

(57) ABSTRACT

A combination strap connector and adjuster for connecting straps of a safety harness and for adjusting at least one of the straps comprises a base including a first connector portion, a second connector portion, and a third connector portion. The first connector portion is configured and arranged to directly connect to a first strap extending in a first direction away from the base. The second connector portion is configured and arranged to directly connect to a second strap extending in a second direction away from the base. The third connector portion is configured and arranged to directly connect to a third strap extending in a third direction away from the base. The first, second, and third directions are different directions relative to the base. An adjuster is operatively connected to at least one of the connector portions.

This application claims the benefit of U.S. Provisional Patent Application Ser. No. 62/743,022, filed Oct. 9, 2018, which is incorporated by reference herein.

### BACKGROUND

Regulations require that a worker or user performing tasks at heights or positions where there is a risk a fall could occur wear fall protection equipment, including a safety harness donned by the user that is connected by a lifeline or lanyard to an anchor point. The properly-adjusted fit of the safety harness is important to the user's safety. A safety harness that is too loose may allow the user to slip free from the harness during a fall. A harness that is improperly adjusted may transfer the load from the lifeline to an unsafe location on the user and lead to suspension trauma or other injuries while the user awaits rescue. The ease of safety harness adjustment is a leading factor in the user's willingness to take the time to correctly adjust his or her harness for safe operation. A difficult or unintuitive harness webbing adjuster may discourage the user from properly adjusting the harness to fit.

For the reasons stated above and for other reasons stated below, which will become apparent to those skilled in the art upon reading and understanding the present specification, a need exists for the present invention.

### SUMMARY

The above-mentioned problems associated with prior devices are addressed by embodiments of the disclosure and will be understood by reading and understanding the present specification. The following summary is made by way of example and not by way of limitation.

In one embodiment, a combination strap connector and adjuster for connecting straps of a safety harness and for adjusting at least one of the straps comprises a base including a first connector portion, a second connector portion, and a third connector portion. The first connector portion is configured and arranged to directly connect to a first strap extending in a first direction away from the base. The second connector portion is configured and arranged to directly connect to a second strap extending in a second direction away from the base. The third connector portion is configured and arranged to directly connect to a third strap extending in a third direction away from the base. The first, second, and third straps are separate straps. The first, second, and third directions are different directions relative to the base. An adjuster is operatively connected to at least one of the connector portions.

In one embodiment, a combination strap connector and adjuster for connecting straps of a safety harness and for adjusting at least one of the straps comprises a base including a first connector portion, a second connector portion, and a third connector portion. The first connector portion is configured and arranged to directly connect to a first strap extending in a first direction away from the base. The second connector portion is configured and arranged to directly connect to a second strap extending in a second direction away from the base. The third connector portion is configured and arranged to directly connect to a third strap extending in a third direction away from the base. The first, second, and third straps are separate straps. The first, second, and third directions are different directions relative to the base. An adjuster is operatively connected to at least one of the connector portions. The adjuster comprises a cam, a locking member, and a biasing member. The locking member is operatively connected to the cam, and the locking member and the cam are operatively connected to the base. The biasing member operatively connects the locking member and the cam to the base.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1 is a front perspective view of an embodiment combination strap connector and adjuster constructed in accordance with the principles of the present invention;

FIG. 2 is a front view of the combination strap connector and adjuster shown in FIG. 1;

FIG. 3 is a top view of the combination strap connector and adjuster shown in FIG. 1;

FIG. 4 is a bottom view of the combination strap connector and adjuster shown in FIG. 1;

FIG. 5 is a first side view of the combination strap connector and adjuster shown in FIG. 1;

FIG. 6 is a second side view of the combination strap connector and adjuster shown in FIG. 1;

FIG. 7 is a rear perspective view of the combination strap connector and adjuster shown in FIG. 1;

FIG. 8 is an exploded perspective view of the combination strap connector and adjuster shown in FIG. 1;

FIG. 9 is a front perspective view of a base of the combination strap connector and adjuster shown in FIG. 1;

FIG. 10 is a front view of the base shown in FIG. 9;

FIG. 11 is a top view of the base shown in FIG. 9;

FIG. 12 is a first side view of the base shown in FIG. 9;

FIG. 13 is a second side view of the base shown in FIG. 9;

FIG. 14 is a perspective view of a cam of the combination strap connector and adjuster shown in FIG. 1;

FIG. 15 is a front view of the cam shown in FIG. 14;

FIG. 16 is a bottom view of the cam shown in FIG. 14;

FIG. 17 is a first side view of the cam shown in FIG. 14;

FIG. 18 is a perspective view of a locking member of the combination strap connector and adjuster shown in FIG. 1;

FIG. 19 is a front view of the locking member of FIG. 18;

FIG. 20 is a top view of the locking member of FIG. 18;

FIG. 21 is a bottom view of the locking member of FIG. 18;

FIG. 22 is a first side view of the locking member of FIG. 18;

FIG. 23 is a front view of the combination strap connector and adjuster shown in FIG. 1 connected to straps of a safety harness; and

FIG. 24 is a front view of a pair of combination strap connector and adjusters constructed in accordance with the principles of the present invention connected to straps of a safety harness.

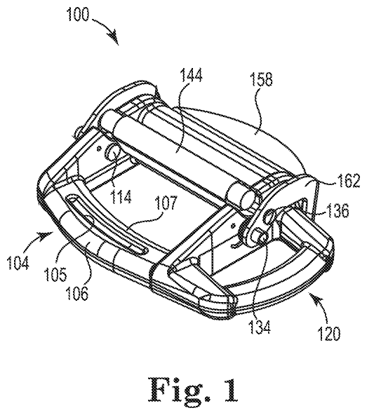

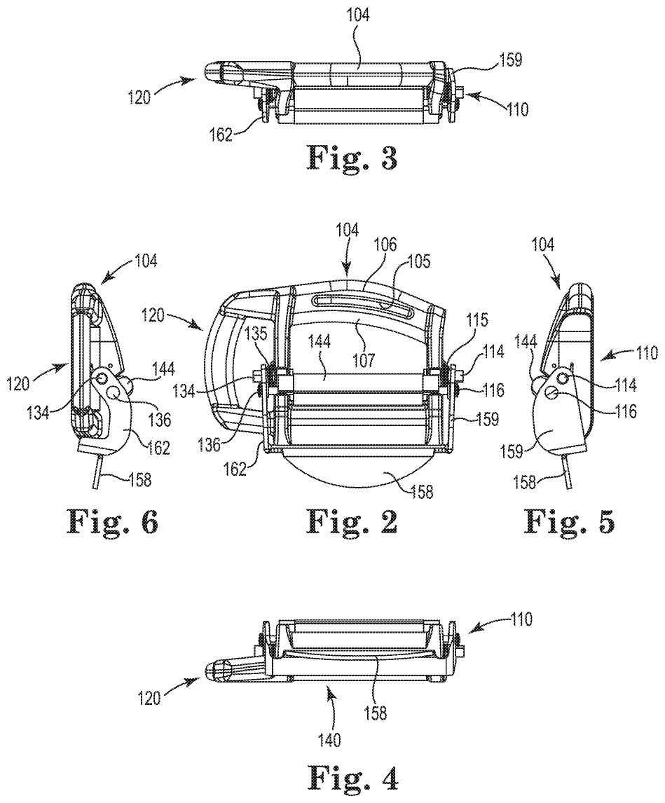

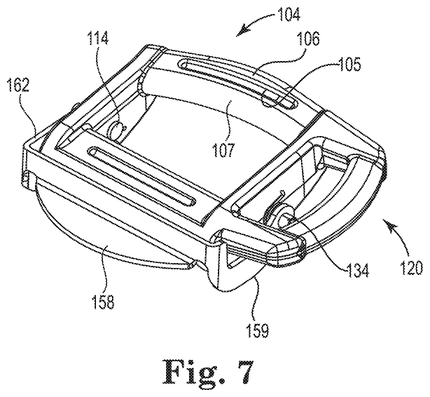

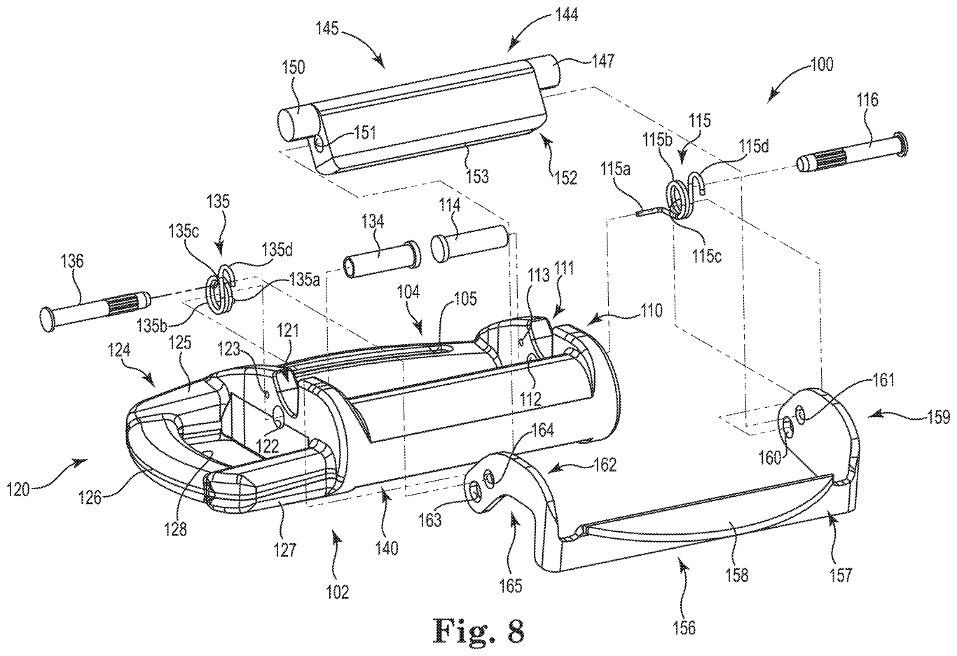

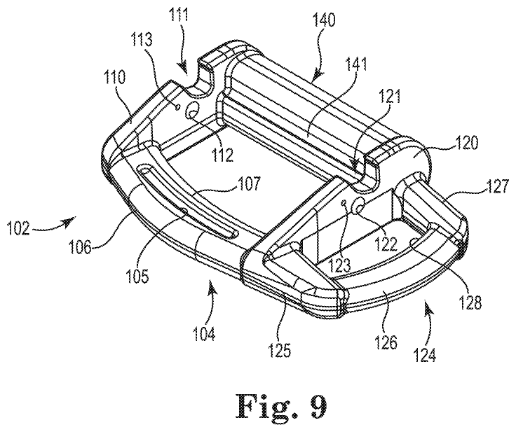

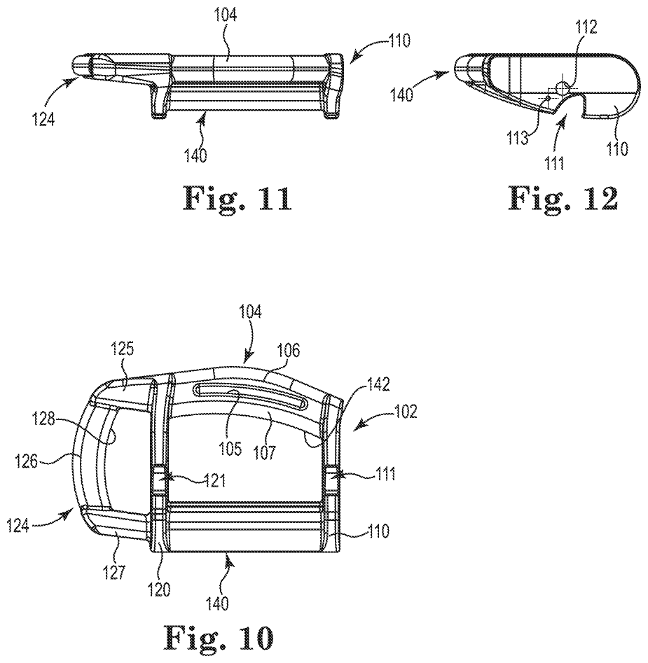

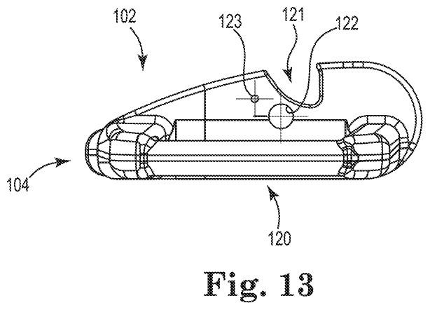

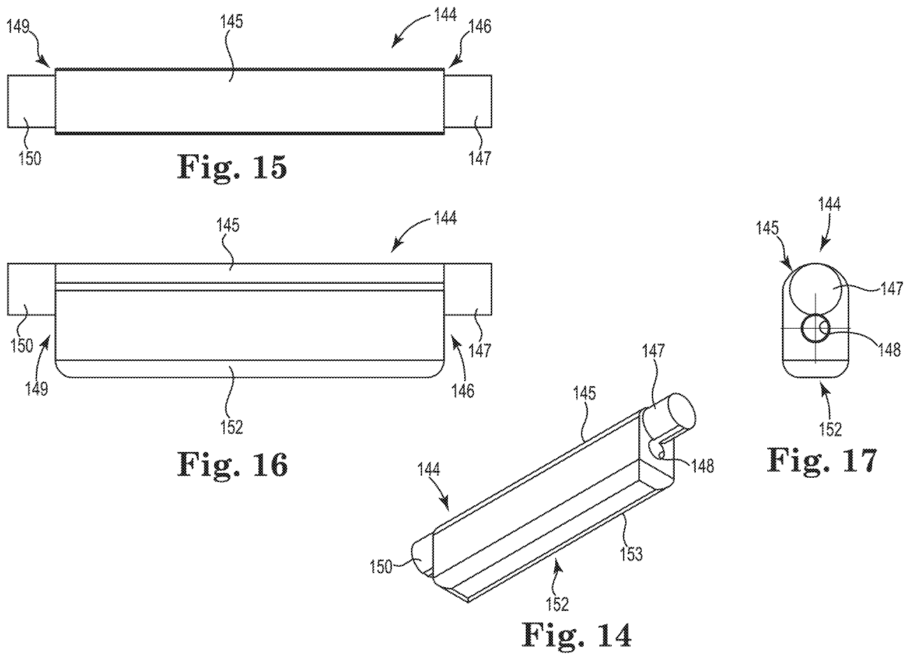

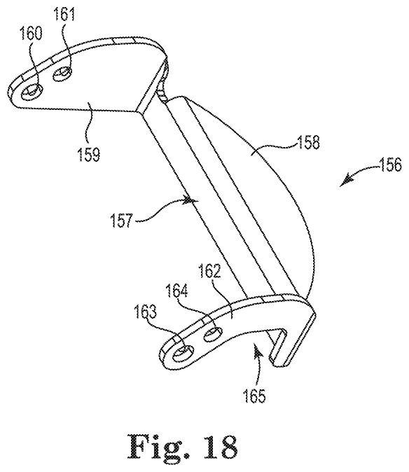

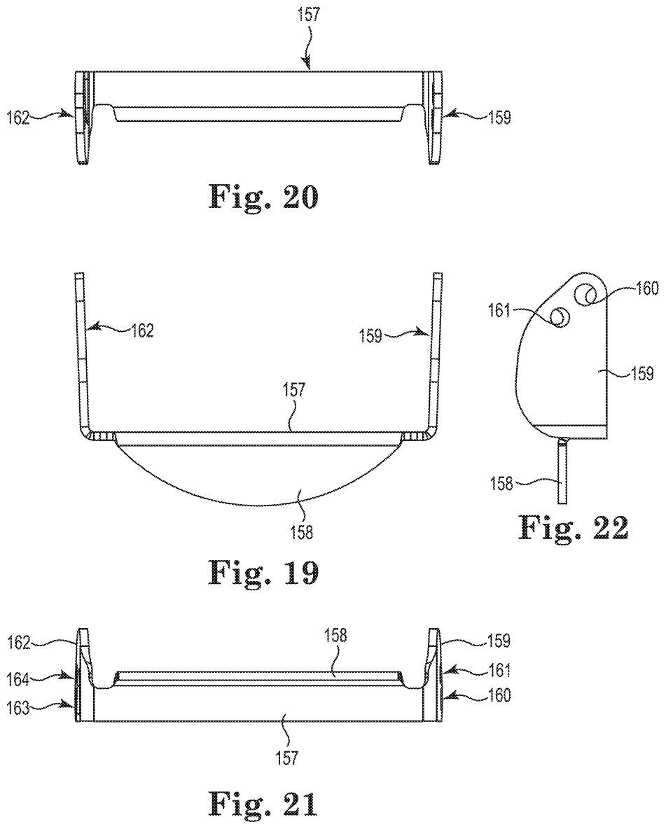

### DETAILED DESCRIPTION

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

Embodiments of the disclosure generally provide a combination strap connector and adjuster for interconnecting straps of a safety harness, with at least one of the straps being adjustable. For example, the combination strap connector and adjuster could be used to interconnect the strap extending about a user's shoulder (shoulder strap), a strap extending toward the user's hip (hip strap), and a strap extending across the user's chest (chest strap). At least one of the straps could be adjustable, for example, in one embodiment the hip strap is adjustable. It is recognized that any one or more of the straps could be adjustable. Optionally, the combination strap connector and adjuster could be configured and arranged to guide the shoulder strap away from the user's neck to reduce chafing.

One example combination strap connector and adjuster 100 includes a base 102, a cam 144, and a locking member 156.

The base 102 includes a top or first connector portion 104 and a bottom or third connector portion 140 interconnected on one side by a first side 110 and on another side by a second side or second connector portion 120 forming an opening 142 therebetween.

The first connector portion 104 includes a slot 105 that forms a top portion 106 and a bottom portion 107. The first side 110 includes a notch 111 proximate a middle portion of the first side 110 and apertures 112 and 113 proximate a side of the notch 111 between the notch 111 and the first connector portion 104. The aperture 112 is proximate a bottom of the notch 111 and the aperture 113 is proximate a top of the notch 111. The second connector portion 120 includes a notch 121 proximate a middle portion of the second connector portion 120 and apertures 122 and 123 proximate a side of the notch 121 between the notch 121 and the first connector portion 104. The aperture 122 is proximate a bottom of the notch 121 and the aperture 123 is proximate a top of the notch 121. The second connector portion 120 also includes an extension 124 extending outward therefrom. The extension 124 includes a top 125 extending outward proximate the first connector portion 104, a bottom 127 extending outward proximate the third connector portion 140, and a side 126 interconnecting the top 125 and the bottom 127. The second connector portion 120 and the extension 124 form an opening 128.

A cam 144 includes a base portion having a top 145, a first side 146, a second side 149, and a bottom 152. A protrusion 147 extends outward from the first side 146 proximate the top 145, and the first side 146 includes a bore 148 below the protrusion 147. A protrusion 150 extends outward from the second side 149 proximate the top 145, and the second side 149 includes a bore 151 below the protrusion 150. The bottom 152 includes an engaging surface 153.

The locking member 156 includes a lever portion 157, from which a flange 158 extends outward, and first and second sides 159 and 162 extending upward therefrom. The first side 159 includes a first aperture 160 proximate its distal end and a second aperture 161 proximate the first aperture 160. The second side 162 includes a first aperture 163 proximate its distal end and a second aperture 164 proximate the first aperture 163.

Other components in this example include fasteners 114 and 134, fasteners 116 and 136, and biasing members 115 and 135. Biasing member 115 includes an intermediate portion 115b interconnecting a first end 115a and a second end 115d. The intermediate portion 115b is generally a coil spring portion forming a bore 115c. Biasing member 135 includes an intermediate portion 135b interconnecting a first end 135a and a second end 135d. The intermediate portion 135b is generally a coil spring portion forming a bore 135c.

To assemble the combination strap connector and adjuster 100, the cam 144 is connected to the locking member 156. A fastener 116 is inserted through the second aperture 161 of the locking member's first side 159 and then into the bore 148 of the cam 144, and a fastener 136 is inserted through the second aperture 164 of the locking member's second side 162 and then into the bore 151 of the cam 144. The cam 144 and locking member 156 are then connected to the base 102. The protrusions 147 and 150 are positioned in the notches 111 and 121, respectively, and the first apertures 160 and 163 of the locking member 156 are aligned with the apertures 112 and 122 in the sides 110 and 120 of the base 102. A fastener 114 is inserted through the aperture 112, through the biasing member's bore 115c, and through the first aperture 160 of the locking member 156. A fastener 134 is inserted through the aperture 122, through the biasing members bore 135c, and through the first aperture 163 of the locking member. The first end 115a of the biasing member 115 is inserted into the aperture 113 of the base 102 and the second end 115d of the biasing member 115 is positioned about the fastener 116. The first end 135a of the biasing member 135 is inserted into the aperture 123 of the base 102 and the second end 135d of the biasing member 135 is positioned about the fastener 136. The cam 144 pivots about its protrusions 147 and 150 relative to the base 102 and pivots about fasteners 116 and 136 relative to the locking member 156. The locking member 156 pivots about fasteners 114 and 134 relative to the base 102. The biasing members 115 and 135 urge the cam 144 and the locking member 156 toward the base 102 into engaged or locked positions.

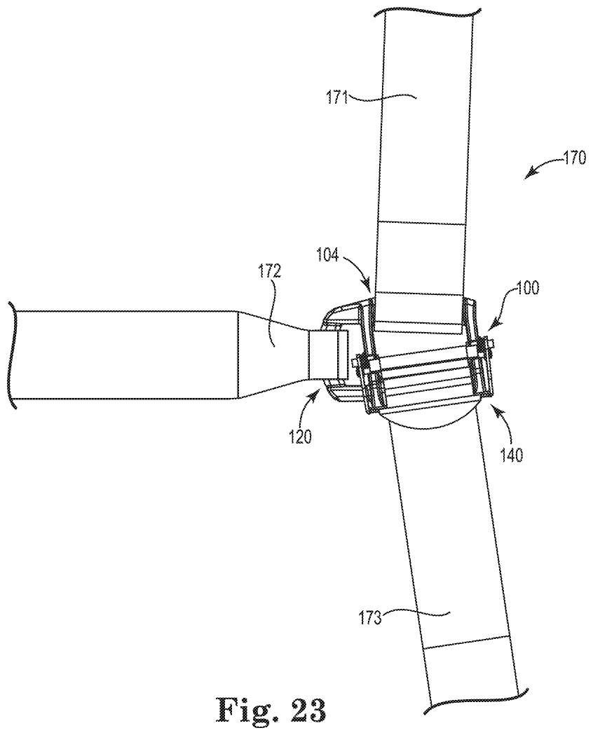

An example safety harness 170 that could be used with the combination strap connector and adjuster 100 includes a shoulder strap 171, a chest strap 172, and a hip strap 173. As shown in FIG. 23, the combination strap connector and adjuster 100 could be used to interconnect the shoulder strap 171, the chest strap 172, and the hip strap 173. In this example, the hip strap 173 is adjustable with a cam buckle as part of the connector portion 140. Although a cam buckle is shown and described, it is recognized that any suitable type of strap adjuster could be used to adjust the length of at least one of the straps.

To connect the shoulder strap 171 to the combination strap connector and adjuster 100, a distal end of the strap 171 is inserted through the slot 105, folded back onto itself about the top portion 106, and secured thereto, for example with a fastener such as stitching. To connect the chest strap 172 to the combination strap connector and adjuster 100, a distal end of the strap 172 is inserted through the opening 128, folded back onto itself about the side 126, and secured thereto, for example with a fastener such as stitching. To connect the hip strap 173 to the combination strap connector and adjuster 100, a distal end of the strap 173 is routed through the opening 142 between the first connector portion 104 and the cam 144, over the top 145 of the cam 144, and between the cam 144 and the third connector portion 140 so that the distal end is positioned proximate an intermediate portion of the strap 173. A suitable keeper could be used to connect the distal end to the intermediate portion to prevent the distal end from getting caught on something during use.

In operation, because the biasing members 115 and 135 urge the cam 144 and the locking member 156 toward the base 102 into engaged or locked positions, the strap 173 is sandwiched between the engaging surface 153 of the cam 144 and the third connector portion 140 of the base 102 and is prevented from moving therebetween. The third connector portion 140 could include a detent or groove 141 to receive the strap 173 and a portion of the engaging surface 153. The strap 173 could be adjusted by moving the cam 144 and the locking member 156 from the engaged or locked positions into disengaged or unlocked positions, which is accomplished by lifting the flange 158 of the locking member 156, thereby overcoming the biasing force of the biasing members 115 and 135 and thereby pivoting the locking member 156 about the fasteners 114 and 134 and moving the cam 144, which is pivoted about the protrusions 147 and 150 relative to the base 102. The cam 144 is moved away from the third connector portion 140 thereby releasing the strap 173. After the strap 173 is adjusted to a desired position, the locking member 156 is released and the biasing members 115 and 135 move the cam 144 and the locking member 156 back into the engaged or locked positions.

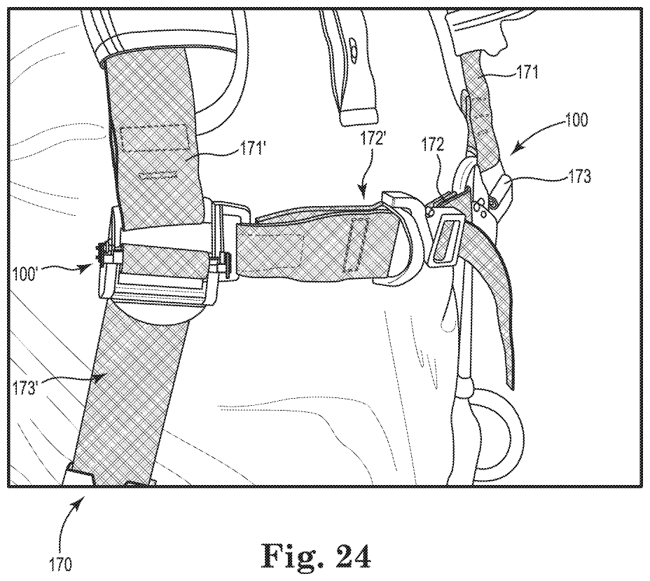

This embodiment illustrates a left side combination strap connector and adjuster and it is understood that a right side combination strap connector and adjuster, which could be a mirror image of the left side combination strap connector and adjuster, could be used to interconnect the left and right harness straps (e.g., shoulder and hip straps) with a chest strap. For example, as shown in FIG. 24, a left side combination strap connector and adjuster 100 interconnects a shoulder strap 171, and chest strap 172, and a hip strap 173 and a right side combination strap connector and adjuster 100′ interconnects a shoulder strap 171′, and chest strap 172′, and a hip strap 173′.

Optionally, the combination strap connector and adjuster base could be configured and arranged to guide the harness strap(s) away from the user's neck to reduce chafing. For example, the top 104 and the bottom 140 could create any suitable angle between the shoulder strap 171 and the hip strap 173.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A combination strap connector and adjuster for connecting straps of a safety harness and for adjusting at least one of the straps, comprising:
a base including a first connector portion, a second connector portion, and a third connector portion, the first connector portion configured and arranged to directly connect to a first strap extending in a first direction away from the base, the second connector portion configured and arranged to directly connect to a second strap extending in a second direction away from the base, and the third connector portion configured and arranged to directly connect to a third strap extending in a third direction away from the base, the first, second, and third straps being separate straps, the first, second, and third directions being different directions relative to the base; and
an adjuster operatively connected to at least one of the connector portions.

2. The combination strap connector and adjuster of claim 1, wherein the third connector portion includes the adjuster, the adjuster being a cam buckle.

3. The combination strap connector and adjuster of claim 1, wherein the adjuster comprises:
a cam;
a locking member operatively connected to the cam, the locking member and the cam being operatively connected to the base; and
a biasing member operatively connecting the locking member and the cam to the base.

4. The combination strap connector and adjuster of claim 3, further comprising a fastener extending through the locking member and the cam, the biasing member interconnecting the fastener and the base.

5. The combination strap connector and adjuster of claim 1, wherein the base is configured and arranged to guide at least one of the straps away from a user's neck to reduce chafing.

6. The combination strap connector and adjuster of claim 1, wherein the first strap is a shoulder strap, the second strap is a chest strap, and the third strap is a hip strap of the safety harness.

7. The combination strap connector and adjuster of claim 6, wherein the base is configured and arranged to guide the shoulder strap and the hip strap away from a user's neck.

8. The combination strap connector and adjuster of claim 6, wherein the third connector portion includes the adjuster and the hip strap is adjustable relative to the base.

9. The combination strap connector and adjuster of claim 8, wherein adjustment of the hip strap adjusts the hip, shoulder, and chest straps relative to a user donning the safety harness.

10. A combination strap connector and adjuster for connecting straps of a safety harness and for adjusting at least one of the straps, comprising:
a base including a first connector portion, a second connector portion, and a third connector portion, the first connector portion configured and arranged to directly connect to a first strap extending in a first direction away from the base, the second connector portion configured and arranged to directly connect to a second strap extending in a second direction away from the base, and the third connector portion configured and arranged to directly connect to a third strap extending in a third direction away from the base, the first, second, and third straps being separate straps, the first, second, and third directions being different directions relative to the base; and
an adjuster operatively connected to at least one of the connector portions, the adjuster comprising:
a cam;
a locking member operatively connected to the cam, the locking member and the cam being operatively connected to the base; and
a biasing member operatively connecting the locking member and the cam to the base.

11. The combination strap connector rand adjuster of claim 10, further comprising a fastener extending through the locking member and the cam, the biasing member interconnecting the fastener and the base.

12. The combination strap connector and adjuster of claim 10, wherein the base is configured and arranged to guide at least one of the straps away from a user's neck to reduce chafing.

13. The combination strap connector and adjuster of claim 10, wherein the first strap is a shoulder strap, the second strap is a chest strap, and the third strap is a hip strap of the safety harness.

14. The combination strap connector and adjuster of claim 13, wherein the base is configured and arranged to guide the shoulder strap and the hip strap away from a user's neck.

15. The combination strap connector and adjuster of claim 13, wherein the third connector portion includes the adjuster and the hip strap is adjustable relative to the base.

16. The combination strap connector and adjuster of claim 15, wherein adjustment of the hip strap adjusts the hip, shoulder, and chest straps relative to a user donning the safety harness.
